(19) United States
(12) Patent Application Publication
(10) Pub. No.: US 2012/0256139 A1
(43) Pub. Date: Oct. 11, 2012

(54) UV-CURABLE COATING CONTAINING CARBON NANOTUBES

(75) Inventors: Robert N. Hunt, Steubenville, OH (US); Charles Todd Williams, Pittsburgh, PA (US)

(73) Assignee: Bayer MaterialScience LLC, Pittsburgh, PA (US)

(21) Appl. No.: 13/082,763

(22) Filed: Apr. 8, 2011

(51) Int. Cl. H01B 1/04; B05D 3/06; B05D 5/12; B05D 3/02; B82Y 30/00

(52) U.S. Cl. 252/510; 427/517; 977/752; 977/902

(57) ABSTRACT

The present invention provides a conductive, curable coating made from about 0.01 wt. % to about 5 wt. %, of multi-walled carbon nanotubes, having a diameter of greater than about 4 nm, about 10 wt. % to about 99 wt. % of an aliphatic urethane acrylate and about 0.1 wt. % to about 15 wt. % of a photoinitiator, wherein the coating is curable by exposure to radiation and wherein the cured coating has a surface resistivity of about 10²Ω/□ to about 10¹⁰Ω/□. A process for the production of such coatings is also provided. There are many applications where carbon nanotubes in a radiation curable coating may enhance properties other than conductivity, such as physical and thermal properties.

### STATEMENT REGARDING FEDERALLY SPONSORED RESEARCH

This invention was made at least in part, through research funded by the U.S. Government under contract number FA 8650-06-3-9000 awarded by the U.S. Air Force Research Laboratory, USAF. The government may have certain rights in the invention.

### FIELD OF THE INVENTION

The present invention relates in general to coatings, and more specifically, to conductive, ultraviolet (UV) curable coatings containing carbon nanotubes.

### BACKGROUND OF THE INVENTION

Morimoto et al., in JP 2008-179787, provide coatings containing UV-curable polymers having≧2 (meth)acryloyl groups, carbon nanotubes, amine-modified acrylic polymers, and photopolymerization initiators. A coating of Morimoto et al. containing dispersant, carbon nanotubes, UV-curable polymer, and photopolymerization initiator was applied on a PET film, dried, and irradiated with UV at 600 mJ/cm² to give a 0.5 μm-thick layer showing surface resistivity of 4.2×10⁷Ω/□, light transmittance of 87.1%, haze of 1.8%, and good scratch, alcohol, and water resistance. Morimoto et al. use low loading levels of carbon nanotube filler and/or thin film coatings having high transmittance which would not inhibit the UV radiation from penetrating and curing the entire coating material. Moromito et al. also require an amine denaturation acrylic polymer as part of their coating.

JP 2008-037919, in the name of Saito et al., describes compositions containing carbon nanotubes surface-coated with doped conducting polymers. A composition of Saito et al. containing carbon nanotubes surface-coated with 7.7% 2-aminoanisole-4-sulfonic acid homopolymer (vol. resistivity 9.0Ω-cm), water, and curable mixtures including dipentaerythritol tetraacrylate, polyethylene glycol diacrylate, and 1-hydroxycyclohexyl Ph ketone was applied on a PET film, dried, and irradiated with UV to give a layer showing surface resistivity of 1.5×10⁵Ω/□, light transmittance of 73.9%, and uniform and colorless surface. Saito et al. use conductive polymers for part of the conductivity and as a possible dispersing agent.

Saito et al., in JP 2007-063481, provide compositions containing electro-conductive polymers, carbon nanotubes, polyfunctional (meth)acrylates, and polymerization initiators. A storage-stable composition of Saito et al. containing 2-aminoanisole-4-sulfonic acid homopolymer benzalkonium chloride salt, carbon nanotube, dipentaerythritol tetraacrylate, and polyethylene glycol diacrylate was applied on a PET film and UV-cured to give a test piece showing surface resistivity of 1.7×10⁵Ω/□ and total transmittance of 67.3%. Saito et al. use electro-conductive polymers to aid in the conductivity of the bulk composition.

U.S. Published Patent Application No. 2006-0128826, in the name of Ellison et al., discloses a cured film made of the reaction product obtained by radiation curing a curable thiol-ene composition containing a multifunctional ethylenically unsaturated compound, a multifunctional thiol, and, optionally, a polymerization initiator, an adhesion promoter, a stabilizer, a surfactant, and/or a conductive filler, the cured film having a thickness<15 μm. The ultrathin films and coatings of Ellison et al. are said to be optically clear, scratch resistant, chemical resistant, and have excellent adhesion to a variety of substrates (e.g. glass, polyethylene terephthalate). Ellison et al. teach that conductive fillers such as carbon nanotubes, metal fiber, metal coated fiber, conductive polymer or oligomer can be used to make the coating conductive, but provide no examples. Further, there is no teaching at what loading of conductive filler (in particular, carbon nanotubes which are strong UV absorbers) the UV cure would be blocked.

Currie et al., in “Hybrid nanocoatings in the display industry” (Journal of the Society for Information Display, 13(9), pp. 773-780 (2005)), report that in the display industry, there is an increasing use of polymeric coatings comprising inorganic nanoparticles. These particles endow the coatings optical, electrical, or mechanical properties not attainable with organic materials, while the use of an organic binder allows easy processing via, e.g., wet deposition and UV or thermal crosslinking. Nanoparticles are relatively new materials and seem to offer numerous opportunities for new coatings for the display industry. Examples provided by Currie et al. are silica nanoparticles in anti-reflection coatings, indium-tin-oxide particles in antistatic coatings, and metallic carbon nanotubes in conductive coatings. The physical interactions which determine the dispersion of nanoparticles in the wet formulation and the resulting morphology in the dry coating are said to be traceable back to classical colloid science.

JP 2009-155570, in the name of Saito et al., provides compositions containing electrically conductive polymers, carbon nanotubes (CNT), electrically conductive particles, and solvents which are applied on at least one surface of substrates and irradiated with radiation and/or stored at ambient temperature or under heat to give composites having coating films. The composition of Saito et al. was applied on a glass substrate and dried to form a uniform coating film showing surface resistivity of 3.1×10⁴Ω/□ and total light transmittance of 75.2%. Saito et al. rely on electrically conductive polymers for improvement of electrical conductivity in their compositions.

Saito et al., in JP 2009-040021, describe structures have coatings containing carbon nanotubes (a), urethanes (b), and particulate matter (c). Applying a 32:58:4:6:0.1:0.1 mixture of HDI trimer-2-hydroxytrimethylene dimethacrylate adduct (1:3), 1,6-hexanediol diacrylate, pentaerythritol tetraacrylate, pentaerythritol triacrylate, multilayer carbon nanotube, and acrylic particle to an acrylic polymer plate and UV-irradiating it through a PET film gave a coating with good carbon nanotube dispersibility. Saito et al. state, the particulate matter is chosen to enhance the properties of interest (physical, electrical, and or optical).

CN 1641820, in the name of Hsiao, et al., details a carbon nanotube coating material made from water, polyvinyl alcohol water-soluble resin, bichromate as photoreaction initiator, carbon nanotubes, glass powder or nitrocotton fiber, a dispersing agent, and conductive powder (such as silver power, indium salt, or indium tin oxide powder). An electron emission source coating was produced by coating carbon nanotube coating material on the cathode substrate by printing, pre-baking at 40-80° C. for 5-20 min, solidifying to form film, exposing for 0.5-3 min under 4,000-6,000 1× UV light, photo-reacting, developing at 30-60° C., drying at 90-110° C. for 5-20 min, and sintering. The coating material of Hsiao, et al., is not only UV-cured, but requires oven baking to develop at 30-60° C. and drying and sintering at 90-110° C. Hsiao, et al. also rely in part on a conductive powder filler for enhancing the overall conductivity.

Trottier, et al., in “Properties and characterization of carbon-nanotube-based transparent conductive coating”, (Journal of the Society for Information Display, 13(9), pp. 759-763, (2005)), describe transparent and electrically conductive coatings and films said to have a variety of applications ranging from window glass to flat-panel displays. These mainly include semiconductive metal oxides such as indium tin oxide and polymers such as poly(3,4-ethylenedioxythiophene) doped and stabilized with poly(styrenesulfonate). In this paper, Trottier, et al. describe alternatives to ITO and conducting polymers, using single-wall carbon nanotubes. These carbon nanotube-based technologies are said to offer conducting substrates having a broad range of conditions, excellent transparency, neutral color tone, good adhesion, abrasion resistance, and flexibility. Additional benefits include ease of both processing and patterning. Trottier, et al. also report on optoelectronic properties and structure characterization of these materials. The carbon nanotube conductive coatings described by Trottier, et al. are fabricated from highly purified acid washed, single-wall carbon nanotubes laid down in ultra thin films of <100 nm with a surface resistance of 10²Ω/□ and are said to be suitable for touch screen displays.

U.S. Pat. No. 7,378,040, issued to Luo et al., is directed to flexible, transparent and conductive coatings and films formed using single wall carbon nanotubes and polymer binders. The coatings and films of Luo et al. are formed from carbon nanotubes applied to transparent substrates forming a single or multiple conductive layers at nanometer level of thickness. Polymer binders are applied to the carbon nanotube network coating having an open structure to provide protection through infiltration. Luo et al. state this provides for the enhancement of properties such as moisture resistance, thermal resistance, abrasion resistance and interfacial adhesion. Polymers may be thermoplastics or thermosets, or any combination of both. Polymers may also be insulative or inherently electrically conductive, or both. Polymers may have single or multiple layers as a basecoat underneath a carbon nanotube coating, or a topcoat above a carbon nanotube coating, or combination of the basecoat and the topcoat forming a sandwich structure. Binder coating thickness can be adjusted by changing binder concentration, coating speed and/or other process conditions. Resulting films and articles can be used as transparent conductors for flat panel display, touch screen, and other electronic devices. Luo et al. provide an example of using a UV cured epoxy binder. However, the conductive carbon nanotube layer is deposited on a substrate in a solvent based solution. After the solvent is flashed off, a dry pure layer of carbon nanotubes is left and must be protected with the application of the binder. The disclosure of Luo et al. describes a multi-step process and is directed to the production of ultra thin, optically transparent, low surface resistance applications such as touch screen displays.

Xia et al., in CN 1164620 provide a polymer/carbon nanotube composite emulsion made of monomer 5-300 parts, carbon nanotube 0.1-600 parts, water 800-1,000 parts, surfactant 1-50 parts, initiator 0-100 parts, and pH regulator 0.1-100 parts. The monomer is methyl or butyl methacrylate, ethyl or butyl acrylate, styrene, butadiene, acrylonitrile, acrylamide, isocyanate, active group-containing vinyl monomer, and/or conductive polymer (such as polyaniline, polypyrrole, polytetramethylene sulfide, or their derivatives). The carbon nanotube with diameter of 0.5-200 nm and length of 200nm-20 μm is single or multi-walled. The surfactant is SPAN, TWEEN, TRITON, OP, sodium dodecyl sulfate, cetyltrimethylammonium bromide, dodecylbenzenesulfonic acid, acrylate, methacrylate, or C₁₂₋₁₈ fatty acid salt. The initiator is (NH₄)₂S₂O₈. The pH regulator is HCl, NaOH, or NaHCO₃. The method of Xia et al. involves mixing the raw materials, polymerizing, at 0-40° for 5 min-5 hours in N₂ ambient under ultrasonic wave radiation (50-1500 W, 2×104-109 Hz) to obtain polymer/carbon nanotube composite seed emulsion; deemulsifying, precipitating, filtering to obtain a polymer-encapsulated carbon nanotube; or polymerizing the seed emulsion again with monomer in the presence of initiator and surfactant for 2-12 hours to obtain a composite emulsion with high solid content. Xia et al. state the polymer-encapsulated carbon nanotubes may be used as conductive fillers, nanometer probes, or super-capacitors. The polymer/carbon nanotube composite emulsion is said to be capable of use as conductive, antistatic, electromagnetic wave-screening, and microwave-absorbing rubber film, coating, adhesive, or rubber products. The polymer/carbon nanotube composite of Xia et al. are not UV-cured.

U.S. Pat. No. 7,118,693, issued to Glatkowski et al., discloses conformal coatings said to provide excellent shielding against electromagnetic interference. The conformal coating is made of an insulating layer and a conducting layer containing electrically conductive material. The insulating layer contains materials for protecting a coated object. The conducting layer is made from materials that provide electromagnetic interference shielding such as carbon black, carbon buckyballs, carbon nanotubes, chemically-modified carbon nanotubes and combinations thereof. The insulating layer and the conductive layer may be the same or different, and may be applied to an object simultaneously or sequentially. The invention of Glatkowski et al. is also directed to objects that are partially or completely coated with a conformal coating that provides electromagnetic interference shielding. Glatkowski et al. provide UV cured coatings, however only UV cured epoxy coatings are provided in the examples and limit the diameter of single wall, double wall, and multiwall nanotubes used in the examples to <3.5 nm.

Glatkowski et al., in U.S. Pat No. 7,060,241, disclose electrically conductive films containing nanotubes that are said to demonstrate excellent conductivity and transparency. Methods of preparing and using the films are also disclosed. Glatkowski et al. fail to mention UV cured polymers and have the same restrictions concerning the diameter and loading of multi-wall nanotubes as the Glatkowski et al. '693 patent above.

Therefore, a need continues to exist in the art for a conductive, radiation curable coating that employs multi-wall carbon nanotubes.

### SUMMARY OF THE INVENTION

Accordingly, the present invention provides a conductive, curable coating made from about 0.01 wt. % to about 5 wt. %, of multi-walled carbon nanotubes, having a diameter of greater than about 4 nm, about 10 wt. % to about 99 wt. % of an aliphatic urethane acrylate and about 0.1 wt. % to about 15 wt. % of a photoinitiator, wherein the coating is curable by exposure to radiation and wherein the cured coating has a surface resistivity of about 10² Ω/□ to about 10¹⁰Ω/□. A process for the production of such coatings is also provided. The inventive coatings may find use in a wide variety of applications.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

The present invention provides a conductive, curable coating made from 0.01 wt. % to 5 wt. % of multi-walled carbon nanotubes having a diameter of greater than 4 nm, 10 wt. % to 90 wt. % of an aliphatic urethane acrylate and 0.1 wt. % to 15 wt. % of a photoinitiator, wherein the weight percentages are based on the weight of the formulation, wherein the coating is curable by exposure to radiation and wherein the cured coating has a surface resistivity of about 10²Ω/□ to 10¹⁰Ω/□.

The present invention further provides a process or producing a conductive, curable coating involving combining 0.01 wt. % to 5 wt. % of multi-walled carbon nanotubes having a diameter of greater than 4 nm, 10 wt. % to 99 wt. % of an aliphatic urethane acrylate and 0.1 wt. % to 15 wt. % of a photoinitiator, wherein the weight percentages are based on the weight of the formulation and curing the coating by exposure to radiation wherein the cured coating has a surface resistivity of 10²Ω/□ to 10¹⁰Ω/□.

Aliphatic urethane acrylates are preferred for use in the conductive, radiation-curable coating of the present invention, with trifunctional aliphatic polyester urethane acrylate oligomers being most preferred, although monomers such as isobornyl acrylate (SR506A from Sartomer) may prove useful in some applications. Illustrative of aliphatic urethane acrylates suitable for use in the present invention include those marketed by Bayer MaterialScience LLC (DESMOLUX U 680 H, DESMOLUX VP LS 2265, DESMOLUX U 100, DESMOLUX U-500, DESMOLUX XP 2491, and DESMOLUX XP 2513), Cognis (PHOTOMER), Cytec Surface Specialties (EBECRYL), Kowa (NK OLIGO U24A and U-15HA), Rahn (GENOMER) and Sartomer. Additional suppliers of aliphatic urethane acrylates include the BR series of aliphatic urethane acrylates (for example, BR 144 and 970) available from Bomar Specialties or the LAROMER series of aliphatic urethane acrylates from BASF.

The aliphatic urethane acrylate may preferably be present in the conductive, radiation-curable coating of the invention an amount of from 10 to 99 wt %, more preferably from 50 to 90 wt %, and most preferably from 40 to 80 wt %, based on the total weight of the formulation. The aliphatic urethane acrylate may be present in the conductive, radiation-curable coating of the present invention in an amount ranging between any combination of these values, inclusive of the recited values.

Photoinitiators are well known to those skilled in the art and are agents that when present in a composition exposed to the correct energy and irradiance in a required band of UV light, polymerization occurs and so the composition hardens or cures. Photoinitiators useful for photocuring free-radically polyfunctional acrylates include benzophenone (e.g., benzophenone, alkyl-substituted benzophenone, or alkoxy-substituted benzophenone); benzoin (e.g., benzoin, benzoin ethers, such as benzoin methyl ether; benzoin ethyl ether, and benzoin isopropyl ether, benzoin phenyl ether, and benzoin acetate); acetophenone, such as acetophenone, 2,2-dimethoxyacetophenone, 4-(phenylthio)acetophenone, and 1,1-dichloroacetophenone; benzil ketal, such as benzil dimethyl ketal, and benzil diethyl ketal; anthraquinone, such as 2-methylanthraquinone, 2-ethylanthraquinone, 2-tertbutylanthraquinone, 1-chloroanthraquinone, and 2-amylanthraquinone; triphenylphosphine; benzoyl-phosphine oxides, such as, for example, 2,4,6-trimethylbenzoyl-diphenyiphosphine oxide; thioxanthone or xanthone; acridine derivative; phenazene derivative; quinoxaline derivative; 1-phenyl-1,2-propanedione-2-O-benzoyloxime; 1-aminophenyl ketone or 1-hydroxyphenyl ketone, such as 1-hydroxycyclohexyl phenyl ketone, phenyl (1-hydroxyisopropyl)ketone and 4-isopropylphenyl(1-hydroxy-isopropyl)ketone; or a triazine compound, for example, 4′″-methyl thiophenyl-1-di(trichloromethyl)-3,5-S-triazine, S-triazine-2-(stilbene)-4,6-bistrichloromethyl, or paramethoxy styryl triazine.

Other photoinitiators include benzoin or its derivative such as α-methylbenzoin; U-phenylbenzoin; α-allylbenzoin; α-benzylbenzoin; benzoin ethers such as benzil dimethyl ketal (available as IRGACURE 651 from Ciba Specialty Chemicals), benzoin n-butyl ether; acetophenone or its derivative, such as 2-hydroxy-2-methyl-1-phenyl-1-propanone (available as DAROCUR 1173 from Ciba Specialty Chemicals) and 1-hydroxycyclohexyl phenyl ketone (available as IRGACURE 184 from Ciba Specialty Chemicals); 2-methyl-1-[4-(methylthio)phenyl]-2-(4-morpholinyl)-1-propanone (available as IRGACURE 907 from Ciba Specialty Chemicals); 2-benzyl-2-(dimethlamino)-1-[4-(4-morpholinyl)phenyl]-1-butanone (available as IRGACURE 369 from Ciba Specialty Chemicals); or a blend thereof.

Another useful photoinitiator includes pivaloin ethyl ether, anisoin ethyl ether; a titanium complex such as bis(η5-2,4-cyclopentadienyl)bis[2,6-difluoro-3-(1H-pyrrolyl)phenyl)t-itanium (commercially available as CGI784DC, also from Ciba Specialty Chemicals); a halomethylnitrobenzene such as 4-bromomethylnitrobenzene and the like; or mono- or bis-acylphosphine (available from Ciba Specialty Chemicals as IRGACURE 1700, IRGACURE 1800, IRGACURE 1850, and DAROCUR 4265). A particularly preferred photoinitiator in the present invention is 20% phosphine oxide, phenyl bis(2,4,6-trimethyl benzoyl)/80% 2-hydroxy-2-methyl-1-phenyl-1-propanone, (available as IRGACURE 2022 from Ciba Specialty Chemicals). Combinations of the aforementioned photoinitiators may also prove useful in the present invention.

The photoinitiator may preferably be present in the conductive, radiation-curable coating of the present invention an amount of from 0.1 to 15 wt %, more preferably from 1 to 7 wt %, and most preferably from 3 to 5 wt %, based on the total weight of the formulation. The photoinitiator may be present in the conductive radiation-curable coating of the present invention in an amount ranging between any combination of these values, inclusive of the recited values.

Carbon nanotubes may be classified into single-walled carbon nanotubes which are rolled graphene sheets, and multi-walled carbon nanotubes, which are nested cylindrical carbon nanotubes with different diameters.

In a multi-walled carbon nanotubes, inner and outer adjacent layers are separated by a distance of 0.3 to 0.4 nm. The space between the two layers is filled with π electron clouds of carbon atoms constituting six-membered rings of the individual layers. The inner and outer layers are concentrically arranged at a constant distance.

Multi-walled carbon nanotubes useful in the present invention may preferably be-used as obtained from the manufacturer at the 95% purity and no additional purification need be done. Multi-walled carbon nanotubes useful in the present invention preferably have a diameter of greater than 4 nm, more preferably between 5-20 nm, a mean diameter of 13-16 nm, and a length of 1->10 μm with a purity of at least 95%. Multi-wall carbon nanotubes useful in the present invention can be produced by a variety of methods, known to those skilled in the art. Some preferred process are described in U.S. Published Patent Application Nos. 2008/0003170, 2008/0293853, 2009/0023851, 2009/0124705 and 2009/0140215, the entire contents of which are incorporated by reference herein.

The multi-walled carbon nanotubes may preferably be present in the conductive, radiation-curable coating of the present invention an amount of from 0.01 to 5 wt %, more preferably from 0.1 to 3 wt %, and most preferably from 2 to 3 wt %, based on the total weight of the formulation. The multi-walled carbon nanotubes may be present in the conductive, radiation-curable coating of the present invention in an amount ranging between any combination of these values, inclusive of the recited values. Resistivities in the range of 10² to 10¹⁰Ω/□ may be achieved by adjusting the amount of multi-walled carbon nanotubes in the conductive, radiation-curable coating formulation.

The inventive coating formulations may be mixed by any suitable means in the art. Particularly preferred is high shear mixing. In a general version of the inventive process, high shear mixing was used to disperse the multi-walled carbon nanotubes into an acrylate and n-butyl acetate formulation to a fineness of grind of>7.5 as measured on a Hegman Gauge (available from BYK-Gardner USA). The high shear mixer used was a DISPERMAT CV available from BYK-Gardner USA. The DISPERMAT CV was operated at 1500-2500 RPM using a 3-inch TEFLON disk submersed in the formulation and 1/16 inch glass beads added as a grinding aid. The formulation was kept cool with an ice bath and additional n-butyl acetate was added as needed to maintain a suitable grind viscosity. After dispersing, the formulation was separated from the glass beads by filtering and the excess solvent was evaporated. Photoinitiator was added and the excess solvent evaporated to a viscosity suitable for screen printing. Loadings of carbon nanotubes up to 4.7% weight percent were achieved in this manner. These coating were cured under 2 full spectrum 300W UV Hg lamps at a line speed of 75 ft/min with a measured UVA exposure of 1.121W/cm² or 0.413 J/cm². The final formulation had a viscosity in the range of 57,500-63,000 cPs that was suitable for screen printing without the addition of monomer to lower the viscosity. High levels of monomer can inhibit the polymerization by increasing the amount of oxygen inhibition and retarding the cure of coatings with high carbon nanotube loadings.

### EXAMPLES

The present invention is further illustrated, but is not to be limited, by the following examples. All quantities given in “parts” and “percents” are understood to be by weight, unless otherwise indicated. The following materials were used in preparing the conductive curable coatings of the examples:
ACRYLATE a UV curable, tough but flexible aliphatic urethane acrylate available as DESMOLUX U100 from Bayer MaterialScience LLC;
PHOTOINITIATOR 1 20% phosphine oxide, phenyl bis(2,4,6-trimethyl benzoyl)/80% 2-hydroxy-2-methyl-1-phenyl-1-propanone, available as IRGACURE 2022 from Ciba Specialty Chemicals, Inc.;
PHOTOINITIATOR 2 1-hydroxycyclohexyl benzophenone 50% in n-butal acetate available as IRGACURE 184 from Ciba Specialty Chemicals, Inc.;
CNT multi-walled carbon nanotubes having>95% purity, available as BAYTUBES C 150 P from Bayer MaterialScience AG;
FLOW AGENT BYK-UV 3500 available from BYK USA Inc.;
BA n-butyl acetate available from Fisher Scientific.

A number of formulations containing mixtures of different U V curable oligomers and/or monomer(s) were prepared to obtain a wide variety of physical properties varying from hard, scratch resistant coatings to flexible, tough coatings.

### Example 1

The following flexible, highly scratch resistant, screen printable conductive coating suitable for fabrication of membrane switches, force sensors, and sensor electrodes on flexible substrates was formulated by combining, 30 g of CNT, 570 g of ACRYLATE and 320 g BA.

This mixture was glass bead milled to a Hegman 8 grind while being ice bath cooled using a DISPERMAT CA running at 1500-2500 RPM using a 3-inch TEFLON disk. As the carbon nanotubes dispersed and the viscosity increased, additional n-butyl acetate was added to maintain efficient grinding. When the Hegman 8 grind was achieved, the glass beads were removed by filtering through a wire screen. 809.6 g of material were recovered with a solids analysis of 53%. To the recovered material 372.7 g of ACRYLATE and 46.7 g of PHOTOINITIATOR 1 was added to bring the percent solids formulation to: 2.5% CNT, 92% ACRYLATE and 5.5% PHOTOINITIATOR 1.

The formulation was high shear mixed as above without glass beads and ice bath cooling to drive off the BA to a total solids to 68.73%. A 2 mil drawdown was made on a glass plate and cured under full spectrum UV Hg lamps with an exposure of 1.085W/cm² or 0.410 J/cm² at a line speed of 20 ft/min. Surface resistivity was measured at 10⁵Ω/□ using a Monroe Model 291 surface resistivity meter available from Monroe Electronics Inc. Sensor electrodes were screen printed with the formulation on flexible 5 mil polyester polyurethane film using a 240 mesh screen and cured under 2 full spectrum 300W UV Hg lamps at 75 ft/min with a measured UVA exposure of 1.121 W/cm² or 0.413 J/cm².

### Example 2

The method of Example 1 was modified by the inclusion of a flow agent, and an additional photoinitiator (PHOTOINITIATOR 2) to provide a harder surface coat. The CNT were dispersed in the ACRYLATE and BA solvent as in Example 1. The photoinitiators and flow agent were added to give the following formulation: 2.96% CNT, 89.90% ACRYLATE, 4.88% PHOTOINITIATOR 1, 1.98% PHOTOINITIATOR 2, and 0.28% FLOW AGENT.

A 2 mil drawdown was made on a glass plate and cured under full spectrum UV Hg lamps with an exposure of 1.085W/cm² or 0.410 J/cm² at a line speed of 20 ft/min. Surface resistivity was measured at 10⁵Ω/□. Sensor electrodes were screen printed with the formulation on flexible 5 mil polyester polyurethane film using a 240 mesh screen and cured under 2 full spectrum 300W UV Hg lamps, at 75 ft/min with a measured UVA exposure of 1.121 W/cm² or 0.413 J/cm².

### Example 3

The method of Example 1 was modified by the inclusion of FLOW AGENT and PHOTOINITIATOR 2 to give a harder surface coat. The CNT were dispersed in the ACRYLATE and BA formulation as in Example 1. The photo initiators and flow agent were then added to give the following formulation: 3.77% CNT, 90.46% ACRYLATE, 4.6% PHOTOINITIATOR 1, 0.9% PHOTOINITIATOR 2, and 0.27% FLOW AGENT.

A 2 mil drawdown was made on a glass plate and cured under full spectrum UV Hg lamps with an exposure of 1.085W/cm² or 0.410 J/cm² at a line speed of 20 ft/min. Surface resistivity was measured at 10⁴Ω/□. Sensor electrodes were screen printed with the formulation on flexible 5 mil polyester polyurethane film using a 240 mesh screen and cured under 2 full spectrum 300W UV Hg lamps at 75 ft/min with a measured UVA exposure of 1.121 W/cm² or 0.413 J/cm².

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. A conductive, curable coating comprising:
about 0.01 wt. % to about 5 wt. % of multi-walled carbon nanotubes having a diameter of greater than about 4 nm;
about 10 wt. % to about 99 wt. % of an aliphatic urethane acrylate; and
about 0.1 wt. % to about 15 wt. % of a photoinitiator,
wherein the weight percentages are based on the weight of the formulation, wherein the coating is curable by exposure to radiation and wherein the cured coating has a surface resistivity of about 10²Ω/□ to about 10¹⁰Ω/□.

2. The conductive, curable coating according to claim 1, wherein the multi-walled carbon nanotubes are present in an amount of about 0.1 wt. % to about 3 wt. %.

3. The conductive, curable coating according to claim 1, wherein the multi-walled carbon nanotubes are present in an amount of about 2 wt. % to about 3 wt %.

4. The conductive, curable coating according to claim 1, wherein the aliphatic urethane acrylate is present in an amount of about 50 wt. % to about 90 wt. %.

5. The conductive, curable coating according to claim 1, wherein the aliphatic urethane acrylate is present in an amount of about 40 wt. % to about 80 wt. %.

6. The conductive, curable coating according to claim 1, wherein the photoinitiator is present in an amount of about 1 wt. % to about 7 wt. %.

7. The conductive, curable coating according to claim 1, wherein the photoinitiator is present in an amount of about 3 wt. % to about 5 wt. %.

8. The conductive, curable coating according to claim 1, wherein the photoinitiator is selected from 20% phosphine oxide, phenyl bis(2,4,6-trimethyl benzoyl)/80% 2-hydroxy-2-methyl-1-phenyl-1-propanone and 1-hydroxycyclohexyl benzophenone.

9. The conductive, curable coating according to claim 1, wherein the multi-walled carbon nanotubes are non-functionalized.

10. The conductive, curable coating according to claim 1, wherein the multi-walled carbon nanotubes having a diameter of about 5 nm to about 20 nm.

11. The conductive, curable coating according to claim 1, wherein the coating is curable by exposure to radiation of about 200 nm to about 420 nm.

12. A process for producing a conductive, curable coating comprising: combining
about 0.01 wt. % to about 5 wt. % of multi-walled carbon nanotubes having a diameter of greater than about 4 nm,
about 10 wt. % to about 99 wt. % of an aliphatic urethane acrylate, and
about 0.1 wt. % to about 15 wt. % of a photoinitiator,
wherein the weight percentages are based on the weight of the formulation; and
curing the coating by exposure to radiation,
wherein the cured coating has a surface resistivity of about 10²Ω/□ to about 10¹⁰Ω/□.

13. The process according to claim 12, wherein the multi-walled carbon nanotubes are present in an amount of about 0.1 wt. % to about 3 wt. %.

14. The process according to claim 12, wherein the multi-walled carbon nanotubes are present in an amount of about 2 wt. % to about 3 wt. %.

15. The process according to claim 12, wherein the aliphatic urethane acrylate is present in an amount of about 50 wt. % to about 90 wt. %.

16. The process according to claim 12, wherein the aliphatic urethane acrylate is presenting an amount of about 40 wt. % to about 80 wt. %.

17. The process according to claim 12, wherein the photoinitiator is present in an amount of about 1 wt. % to about 7 wt. %.

18. The process according to claim 12, wherein the photoinitiator is present in an amount of about 3 wt. % to about 5 wt. %.

19. The process according to claim 12, wherein the photoinitiator is selected from 20% phosphine oxide, phenyl bis(2,4,6-trimethyl benzoyl)/80% 2-hydroxy-2-methyl-1-phenyl-1-propanone and 1-hydroxycyclohexyl benzophenone.

20. The process according to claim 12, wherein the multi-walled carbon nanotubes are non-functionalized.

21. The process according to claim 12, wherein the multi-walled carbon nanotubes having a diameter of about 5 nm to about 20 nm.

22. The process according to claim 12, wherein the coating is cured by exposure to radiation of about 200 nm to about 420 nm.
